(19) United States
(12) Patent Application Publication
(10) Pub. No.: US 2019/0155740 A1
(43) Pub. Date: May 23, 2019

(54) SEMICONDUCTOR DEVICE AND CACHE MEMORY CONTROL METHOD FOR REDUCING POWER CONSUMPTION

(71) Applicant: RENESAS ELECTRONICS CORPORATION, Tokyo (JP)

(72) Inventor: Naoshi ISHIKAWA, Tokyo (JP)

(21) Appl. No.: 16/256,728

(22) Filed: Jan. 24, 2019

Related U.S. Application Data
(63) Continuation of application No. 15/155,797, filed on May 16, 2016.

(30) Foreign Application Priority Data
Jul. 7, 2015 (JP) 2015-135916

(51) Int. Cl. G06F 12/0897

(52) U.S. Cl. CPC G06F 12/0897; Y02D 10/13; G06F 2212/1028

(57) ABSTRACT

An object of the present invention is to effectively reduce power consumption. A semiconductor device according to the present invention includes a first cache memory, a second cache memory whose power consumption is larger than that of the first cache memory, and a main memory whose power consumption is larger than that of the second cache memory. Capacity of each of the first and second cache memories is determined so that a total value of values obtained by adjusting current values of the first cache memory, the second cache memory, and the main memory in accordance with hit ratios of the memories becomes a predetermine current threshold or less.

### CROSS-REFERENCE TO RELATED APPLICATIONS

This is a Continuation of U.S. patent application Ser. No. 15/155,797 filed on May 16, 2016, which claims the benefit of Japanese Patent Application No. 2015-135916 filed on Jul. 7, 2015 including the specification, drawings and abstract are incorporated herein by reference in their entirety.

### BACKGROUND

The present invention relates to a semiconductor device and a cache memory control method and, for example, relates to a semiconductor device having a cache memory.

In a microcomputer, when a large wait occurs at the time of accessing a main memory, to improve the performance, a cache memory is disposed between a bus master (for example, a CPU (Central Processing Unit)) and the main memory. A cache memory has a trade-off relation between speed (the number of waits) and capacity (area, cost). A cache memory is hierarchized by coupling a high-speed small-capacity cache memory and a low-speed large-capacity cache memory in series. The capacity of the cache memory in this case is determined so that the performance per cost becomes the highest.

Patent Literature 1 discloses a cache memory device aiming at maximally utilizing high-speed access performance of a high-speed small-capacity cache and high hit ratio of a low-speed large-capacity cache. In the cache memory device, when a load request is issued by a virtual address from an arithmetic control unit, a high-speed small-capacity virtual cache and a TLB (Translation Look-aside Buffer: address conversion buffer) are accessed. When a hit occurs in the high-speed small-capacity virtual cache, data in an entry which is hit is selected by a selector and output to the arithmetic control unit. When a mishit occurs in the high-speed small-capacity virtual cache, a low-speed large-capacity physical cache is accessed by a physical address translated by using the TLB. When a hit occurs in the low-speed large-capacity physical cache, data in an entry which is hit is selected by a selector and output to the arithmetic control unit.

Patent Literature 2 discloses an information processing device aiming at rationalizing control of a hierarchized memory made by a high-order memory and a low-order memory and reducing wasted power consumption by the high-order memory. In the information processing device, at the time of high-speed operation of a processor, a CPU core controls to issue an information output request to both a cache memory and an MMU at the same time. At the time of low-speed operation of the processor, the CPU core issues the information output request only to the MMU.

Although the cache memory device disclosed in the patent literature 1 aims at improvement in high-speed access performance and high hit ratio, a technique to reduce power consumption is not disclosed. Although the information processing device disclosed in the patent literature 2 aims at reduction in power consumption by issuing only the request to the low-order memory at the time of low-speed operation of the processor, the power consumption is reduced only at the time of low-speed operation of the processor. There is consequently a problem that the effect of reducing power consumption is limited.

### RELATED ART LITERATURE

### Patent Literature

### Patent Literature 1

Japanese Unexamined Patent Application Publication No. Hei 5(1993)-35589

### Patent Literature 2

Japanese Unexamined Patent Application Publication No. Hei 11(1999)-143776

### SUMMARY

As described above, the techniques disclosed in the patent literatures 1 and 2 have a problem that power consumption cannot be reduced effectively.

The other objects and novel features will become apparent from the description of the specification and the appended drawings.

In an embodiment, in a semiconductor device, capacity of each of first and second cache memories is determined so that a total value of values obtained by adjusting current values of the first cache memory, the second cache memory, and a main memory in accordance with hit ratios of the memories becomes a predetermine current threshold or less.

According to the embodiment, power consumption can be reduced effectively.

### BRIEF DESCRIPTION OF THE DRAWINGS

FIG. 1 is a block diagram illustrating the configuration of a semiconductor device according to a first embodiment.

FIG. 2 is a diagram illustrating the relation between the capacities of first and second cache memories and area.

FIG. 3 is a diagram illustrating the relation between the capacities of the first and second cache memories and current.

FIG. 4 is a block diagram illustrating a detailed configuration of the first and second cache memories according to the first embodiment.

FIG. 5 is a timing chart of signals processed in the first and second cache memories according to the first embodiment.

FIG. 6 is a flowchart illustrating operation of the semiconductor device according to the first embodiment.

FIG. 7 is a block diagram illustrating the configuration of a semiconductor device according to a second embodiment.

FIG. 8 is a timing chart of signals processed in a second cache memory according to the second embodiment.

FIG. 9 is a flowchart illustrating operation of the semiconductor device according to the second embodiment.

FIG. 10 is a block diagram illustrating a detailed configuration of first and second cache memories according to a third embodiment.

FIG. 11 is a timing chart of signals processed in the second cache memory according to the third embodiment.

### DETAILED DESCRIPTION

Hereinafter, preferred embodiments will be described with reference to the drawings. Concrete numerical values and the like described in the following embodiments are just an example to facilitate understanding of the embodiments and, unless otherwise mentioned, the invention is not limited to them. In the following description and the drawings, to clarify the description, matters obvious to a person skilled in the art and the like are properly omitted or simplified.

### First Embodiment

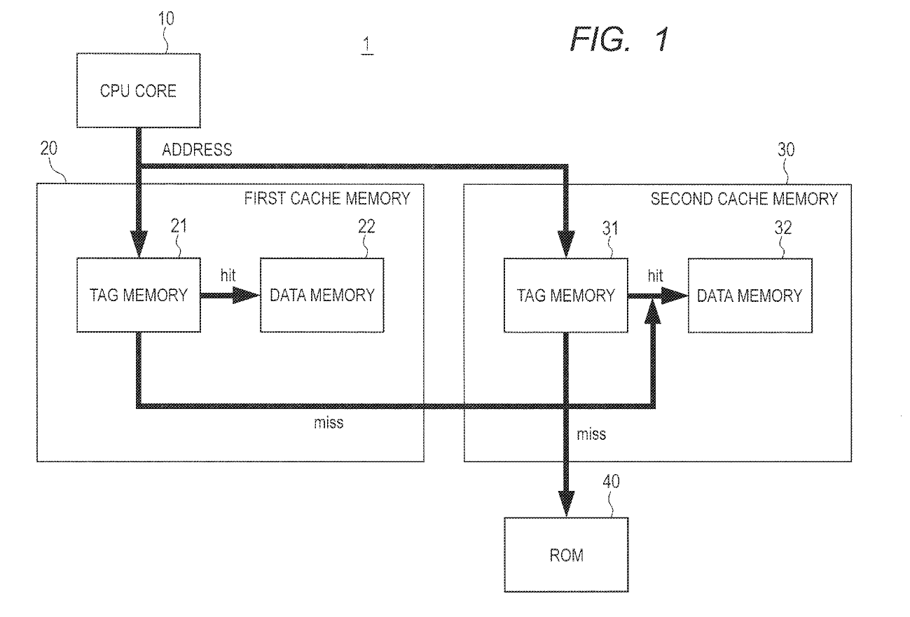

Referring to FIG. 1, the configuration of a semiconductor device 1 according to a first embodiment will be described. FIG. 1 is a block diagram illustrating the configuration of the semiconductor device 1 according to the first embodiment.

As illustrated in FIG. 1, the semiconductor device 1 has a CPU core 10, a first cache memory 20, a second cache memory 30, and a ROM (Read Only Memory) 40.

The CPU core 10 is an arithmetic circuit reading data stored in the ROM 40 and executing a process based on the read data. For example, the CPU core 10 reads a program stored in the ROM 40 and executes the read program, thereby executing the process. In the case where a copy of data planned to be read from the ROM 40 is stored in the first cache memory 20 or the second cache memory 30, the CPU core 10 reads the copied data from the first cache memory 20 or the second cache memory 30 in place of the ROM 40.

The first cache memory 20 is a storage circuit in which a copy of the data stored in the ROM 40 is temporarily stored. The first cache memory 20 is a memory at a level higher than the second cache memory 30 and the ROM 40. The capacity (storable data amount) of the first cache memory 20 is smaller than that of the second cache memory 30 and the ROM 40. The power consumption and the amount of data which can be stored per unit area in the first cache memory 20 are smaller than those of the second cache memory 30 and the ROM 40. The access speed to data from the CPU core 10 of the first cache memory 20 is equal to that of the second cache memory 30 and faster than that of the ROM 40.

The first cache memory 20 has a tag memory 21 and a data memory 22. In the tag memory 21, an address in the ROM 40 of data whose copy is stored in the data memory 22 is stored. In the data memory 22, data which is a copy of the data stored in the ROM 40 is stored. When a copy of data in the ROM 40 requested to be read by the CPU core 10 is stored in the first cache memory 20, the copied data is output to the CPU core 10.

More concretely, the data memory 22 has a plurality of entries. Each of the plurality of entries of the data memory 22 can store copies of data indifferent addresses in the ROM 40. The tag memory 21 has a plurality of entries corresponding to the plurality of entries of the data memory 22. In each of the plurality of entries of the tag memory 21, the address in the ROM 40 of the data whose copy is to be stored in the corresponding entry in the data memory 22 is stored.

The CPU core 10 designates an address in the ROM 40 of the data and sends a request to read the data. When there is a request to read the data from the CPU core 10, the first cache memory 20 retrieves an address matching the address designated by the CPU core 10 from the plurality of entries of the tag memory 21. When an address matching the address designated by the CPU core 10 is detected (when the first cache memory 20 is hit), the first cache memory 20 outputs data stored in an entry in the data memory 22 corresponding to the entry in which the detected address is stored to the CPU core 10. By the operation, the CPU core 10 can read data from the first cache memory 20 which is faster than the ROM 40 in place of the ROM 40.

The second cache memory 30 is a storage circuit in which a copy of the data stored in the ROM 40 is temporarily stored. The second cache memory 30 is a memory at a level lower than the first cache memory 20 and higher than the ROM 40. The capacity (storable data amount) of the second cache memory 30 is larger than that of the first cache memory 20 and smaller than that of the ROM 40. The power consumption and the amount of data which can be stored per unit area in the second cache memory 30 are larger than those of the first cache memory 20. On the other hand, the power consumption and the amount of data which can be stored per unit area in the second cache memory 30 are smaller than those of the ROM 40. The access speed to data from the CPU core 10 of the second cache memory 30 is equal to that of the first cache memory 20 and faster than that of the ROM 40.

The second cache memory 30 has a tag memory 31 and a data memory 32. The tag memory 31 stores an address in the ROM 40 of data whose copy is stored in the data memory 32. In the data memory 32, data which is a copy of the data stored in the ROM 40 is stored. When a copy of data in the ROM 40 requested to be read by the CPU core 10 is stored in the second cache memory 30, the second cache memory 30 outputs the copied data to the CPU core 10.

More concretely, like the tag memory 21 and the data memory 22 of the first cache memory 20, each of the tag memory 31 and the data memory 32 of the second cache memory 30 has a plurality of entries. Since data stored in each of the entries in the tag memory 31 and the data memory 32 and the operation of the second cache memory 30 using the data are similar to those in the first cache memory 20 described above, the description will not be given here.

The second cache memory 30 performs an address search for the tag memory 31 and an address search for the tag memory 21 in the first cache memory 20 in parallel. Even when the address matching the address designated by the CPU core 10 is detected (a hit occurs in the second cache memory 30), only in the case where the first cache memory 20 does not detect an address matching the address designated by the CPU core 10 (when a mishit occurs in the first cache memory 20), the second cache memory 30 outputs data to the CPU core 10. Consequently, even when a mishit occurs in the first cache memory 20, the CPU core 10 can read data from the second cache memory 30 whose speed is higher than that of the ROM 40 in place of the ROM 40.

When a mishit occurs in both of the first and second cache memories 20 and 30, the CPU core 10 reads data from the ROM 40.

The ROM 40 is a storage circuit in which various data used to execute a process by the CPU 10 is stored. The data includes, for example, a program to be executed by the CPU core 10 as described above. The ROM 40 functions as a main memory. The ROM 40 may be, for example, a flash memory.

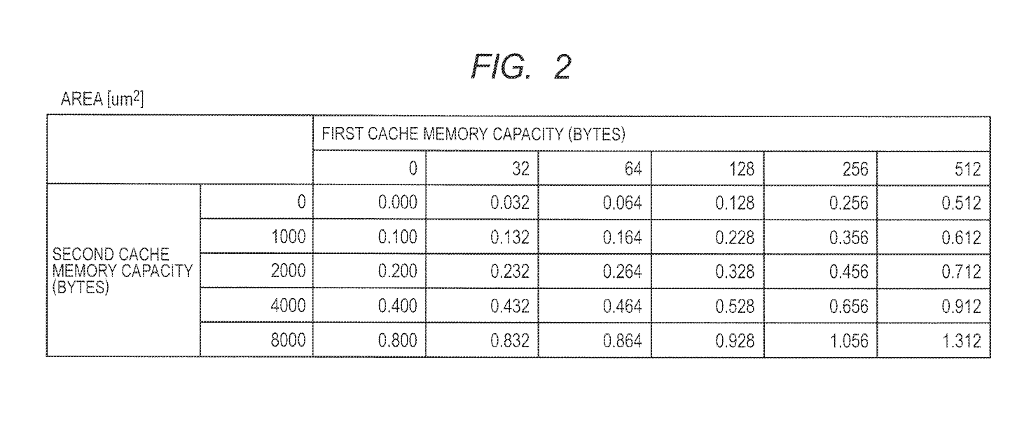

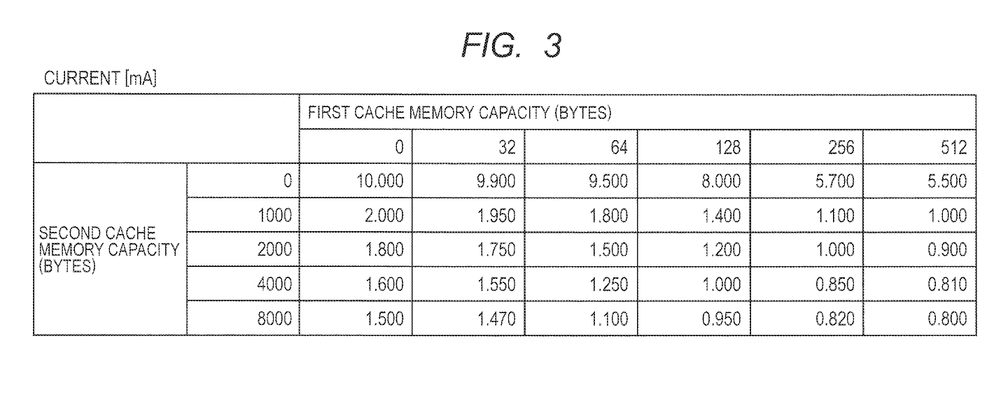

Next, referring to FIGS. 2 and 3, a method of determining capacity of the first and second cache memories 20 and 30 according to the first embodiment will be described. FIG. 2 is a table illustrating the relation between the capacities of the first and second cache memories 20 and 30 and the total of areas of the first and second cache memories 20 and 30. FIG. 3 is a table illustrating the relation between the capacities of the first and second cache memories 20 and 30 and the total of currents in the first cache memory 20, the second cache memory 30, and the ROM 40.

In the first embodiment, an example that speed (access speed to data from the CPU core 10), area (area per 1 Kbyte), and current of each of the first cache memory 20, the second cache memory 30, and the ROM 40 are as follows will be described. More concretely, the current is average consumption current when data is accessed successively. The average consumption current may be obtained by, for example, evaluating the consumption powers of the first cache memory 20, the second cache memory 30, and the ROM 40 in advance by some benchmark programs.

### First Cache Memory 20

Speed: 0 wait, area: 1.0 um²/Kbyte, current: 0.1 mA

### Second Cache Memory 30

Speed: 0 wait, area: 0.1 um²/Kbyte, current: 1 mA ROM 40
Speed: 8 waits, area: 0.01 um²/Kbyte, current: 10 mA

As described above, the memory has a tradeoff relation between the area per unit capacity and consumption power. In the first embodiment, in consideration of the relation, the memory configuration is optimized to minimize consumption power per area (cost).

FIG. 2 illustrates the total area of the first cache memory 20 and the second cache memory 30 for each of combinations between the capacities of the first cache memory 20 of 0 byte, 32 bytes, 64 bytes, 128 bytes, 256 bytes, and 512 bytes and the capacities of the second cache memory 30 of 0 byte, 1,000 bytes, 2,000 bytes, 4,000 bytes, and 8,000 bytes.

The total area can be calculated by adding a value obtained by multiplying the area per Kbyte with capacity (K-byte unit) of the first cache memory 20 and a value obtained by multiplying the area per Kbyte with capacity of the second cache memory 30. As a result, the total area is obtained as illustrated in FIG. 2 for each of the combinations of the capacity of the first cache memory 20 and the capacity of the second cache memory 30.

FIG. 3 illustrates the total current of the first cache memory 20, the second cache memory 30, and the ROM 40 for each of combinations between the capacities of the first cache memory 20 of 0 byte, 32 bytes, 64 bytes, 128 bytes, 256 bytes, and 512 bytes and the capacities of the second cache memory 30 of 0 byte, 1,000 bytes, 2,000 bytes, 4,000 bytes, and 8,000 bytes. The total current is calculated by the following equation (1).

Total current=current of first cache memory 20×hit ratio A of first cache memory 20+current of second cache memory 30×hit ratio B of second cache memory 30+current of ROM 40×hit ratio (1-A-B) of ROM 40 (1)

The hit ratio of the first cache memory 20 becomes higher as the capacity of the first cache memory 20 increases. The hit ratio of the second cache memory 30 becomes higher as the capacity of the second cache memory 30 increases. The hit ratio of the ROM 40 becomes higher as the capacity of the first and second cache memories 20 and 30 decreases (hit ratio becomes lower).

It is assumed that, in this case, the area request is 0.8 um² or less and the current request is 0.9 mA or less. The following two combinations of a configuration satisfy the requests.

{Capacity of first cache memory 20, capacity of second cache memory 30}={256 bytes, 4 Kbytes}, {512 bytes, 2 Kbytes}

Therefore, in this case, the capacity of the first cache memory 20 and the capacity of the second cache memory 30 are determined in any of the two combinations.

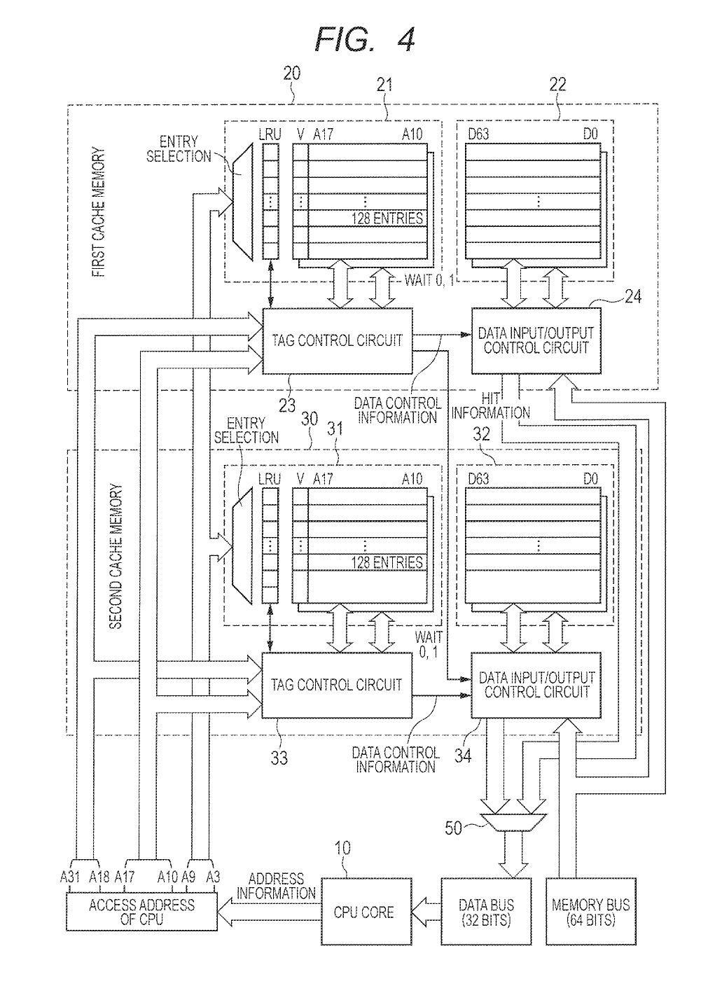

Subsequently, referring to FIG. 4, the detailed configuration of the first and second cache memories 20 and 30 according to the first embodiment will be described. FIG. 4 is a block diagram illustrating a detailed configuration of the first and second cache memories 20 and 30 according to the first embodiment.

The first cache memory 20 has, in addition to the tag memory 21 and the data memory 22, a tag control circuit 23 and a data input/output control circuit 24. FIG. 4 illustrates an example that the first cache memory 20 is a cache memory employing a 2-way set associative method.

As described above, the tag memory 21 has a plurality of entries. FIG. 4 illustrates an example that the number of entries per way is 128. Since the number of ways is two, the number of entries is 128×2 in total. Each of the 128 entries per way is associated with possible values in the third to ninth bits in an address in the ROM 40 of 32 bits (zeroth bit to 31th bit) designated by the CPU core 10. That is, the third to ninth bits in an address in the ROM 40 of 32 bits designated by the CPU core 10 correspond to a so-called entry address. The tag memory 21 has two entries (the number of ways) corresponding to the same entry address.

As described above, the tag memory 21 has a plurality of entries. Like the tag memory 21, in the data memory 22, the number of entries is 128×2. As described above, each of the plurality of entries in the data memory 22 corresponds to each of the plurality of entries in the tag memory 21. That is, in an entry in the data memory 22 corresponding to an entry in the tag memory 21, a copy of data stored in an address specified by the entry in the tag memory 21 in the ROM 40 is stored.

Each of the entries in the tag memory 21 includes a region storing an LRU (Least Recently Used) bit, a region storing a valid bit, and a region storing values in the tenth to 17th bits (so called a frame address) in the address in the ROM 40.

The LRU bit is data indicating an entry in which oldest data since the last access (oldest accessed data) is stored in two entries specified by the same entry address. For example, in the two entries, the entry storing oldest data since the last access indicates “1”, and the entry storing data which is not oldest since the last access (not oldest accessed data) indicates “0”.

The valid bit is data indicating whether data stored in an entry in the data memory 22 corresponding to the entry storing the valid bit is valid or invalid. For example, when data in the data memory 22 is valid, the valid bit indicates that the data is valid (for example, “1”) and, when data in the data memory 22 is invalid, the valid bit indicates that the data is invalid (for example, “0”).

As described above, the frame address indicates values in the zeroth to 17th bits in the address in the ROM 40 of data whose copy is stored in an entry in the data memory 22 corresponding to the entry storing the frame address. Therefore, when the values in the zeroth to 17th bits in the address in the ROM 40 of 32 bits designated by the CPU core 10 match the frame address stored in the entry specified by the entry address, it means that a copy of the data of the address in the ROM 40 designated by the CPU core 10 is stored in the data memory 22.

The tag control circuit 23 performs controls related to the tag memory 21 such as (1) ROM region determination, (2) address comparison, (3) V bit control, and (4) LRU control.

### (1) ROM Region Determination

The tag control circuit 23 determines whether the address in the ROM 40 is designated or not on the basis of the values from the 18th to 31th bits in the address in the ROM 40 of 32 bits designated by the CPU core 10. For example, when the address in the ROM 40 is mapped to 0000-0000h to 000F-FFFFh, the tag control circuit 23 determines whether all of the upper 16 bits in the values in the 18th to 31th bits are zero or not. When all of the upper 16 bits are zero, the tag control circuit 23 determines that an address in the ROM 40 is designated. On the other hand, when all of the upper 16 bits are not zero, the tag control circuit 23 determines that an address in the ROM 40 is not designated. When it is determined that an address in the ROM 40 is designated, the tag control circuit 23 performs (2) address comparison to be described hereinafter. On the other hand, when it is determined that an address in the ROM 40 is not designated, the tag control circuit 23 does not perform the (2) address comparison.

### (2) Address Comparison

The tag control circuit 23 compares frame addresses stored in two entries specified by the entry address in the address in the ROM 40 of 32 bits designated by the CPU core 10 with the frame address in the address in the ROM 40 of 32 bits designated by the CPU core 10. For example, by entering the entry address in the address in the ROM 40 designated by the CPU core 10 to the tag memory 21, the tag memory 21 outputs data stored in the two entries corresponding to the entry address to the tag control circuit 23. The tag control circuit 23 performs the address comparison on the basis of the data output from the tag memory 21.

When the compared addresses match, the tag control circuit 23 determines that a copy of the data of the address in the ROM 40 designated by the CPU core 10 is stored in the data memory 22 (a hit occurs in the first cache memory 20). In this case, the tag control circuit 23 outputs data control information instructing output of the data to the data input/output control circuit 24 and outputs hit information indicative of occurrence of a hit to a data input/output control circuit 34 in the second cache memory 30. The data control information indicates an entry in the data memory 22 corresponding to the entry in which the frame address matching the frame address in the address in the ROM 40 designated by the CPU core 10 is stored.

On the other hand, when the compared addresses do not match, the tag control circuit 23 determines that a copy of the data of the address in the ROM 40 designated by the CPU core 10 is not stored in the data memory 22, that is, a mishit occurs. In this case, the tag control circuit 23 does not output data control information instructing output of data to the data input/output control circuit 24 but outputs hit information indicating of no hit (occurrence of a mishit) to the data input/output control circuit 34 in the second cache memory 30.

### (3) V-bit Control

When the data input/output control circuit 24 stores a copy of the data of the ROM 40 in any of the entries in the data memory 22, the tag control circuit 23 updates the valid bit in the entry in the tag memory 21 corresponding to the entry to “valid”. When a copy of the data of the ROM 40 stored in any of the entries in the data memory 22 is made invalid, the tag control circuit 23 updates the valid bit in the entry in the tag memory 21 corresponding to the entry to “invalid”.

### (4) LRU Control

When data stored in any of the entries in the data memory 22 is accessed, the tag control circuit 23 updates the LRU bit in the entry in the tag memory 21 corresponding to the entry to indicate that time since the last access is the longest, and updates the LRU bit in an entry of the other way corresponding to the same entry address as the entry to indicate that time since the last access is not the longest.

The data input/output control circuit 24 obtains, from the data memory 22, a copy of the data of the ROM 40 stored in the entry indicated by the data control information in accordance with the data control information from the tag control circuit 23 and outputs the obtained data to a selection circuit 50.

The second cache memory 30 has, in addition to the tag memory 31 and the data memory 32, a tag control circuit 33 and a data input/output control circuit 34. FIG. 4 illustrates an example that the second cache memory 30 is, like the first cache memory 20, a cache memory employing a 2-way set associative method.

Since the operations of the tag memory 31, the data memory 32, the tag control circuit 33, and the data input/output control circuit 34 are similar to those of the tag memory 21, the data memory 22, the tag control circuit 23, and the data input/output control circuit 24, the description will not be repeated.

Different from the tag control circuit 23, the tag control circuit 33 does not output hit information. Different from the data input/output control circuit 24, when hit information indicative of no hit is output from the tag control circuit 23 even in the case where the data control information is output from the tag control circuit 43, the data input/output control circuit 34 does not execute the operation of obtaining data from the data memory 22 and outputting it to the selection circuit 50.

The selection circuit 50 selectively outputs any one of data output from the data input/output control circuit 24 in the first cache memory 20 and data output from the data input/output control circuit 34 in the second cache memory 30 to the CPU core 10 via the data bus.

When a hit occurs in the first cache memory 20, the selection circuit 50 selects the data output from the data input/output control circuit 24 and outputs it to the CPU core 10. When a mishit occurs in the first cache memory 20 and a hit occurs in the second cache memory 30, the selection circuit 50 selects the data output from the data input/output control circuit 34 and outputs it to the CPU core 10. The CPU core 10 obtains the output data as reading of the data of the ROM 40.

In this case, the data input/output control circuit 24 stores the data output from the data input/output control circuit 34 into the data memory 22. The data is stored in an entry in the data memory 22 corresponding to the entry address in the address of the data. The data is stored selectively into one of two entries corresponding to the entry address; an entry in the tag memory 21 whose valid bit indicates “invalid”, and an entry in the data memory 22 corresponding to the entry in the tag memory 21 whose valid bit indicates “valid” and the LRU bit indicates that time since the last access is longest.

At this time, the tag control circuit 23 updates data of each of the entries in the tag memory 21 corresponding to the entries storing data. More concretely, when the valid bit indicates “invalid”, the tag control circuit 23 changes the data to indicate “valid”. The tag control circuit 23 changes the LRU bit a value indicating that time since the last access is not longest and changes the LRU bit in the entry in the other way corresponding to the same entry address to a value indicating that time since the last access is the longest. The tag control circuit 23 changes the frame address to the values in the 10th to 17th bits in the address in the ROM 40 of the original data which was copied.

On the other hand, when a mishit occurs in both of the first and second cache memories 20 and 30, the CPU core 10 reads data from the ROM 40. That is, the ROM 40 outputs the data stored in the address designated by the CPU core 10 to the CPU core 10. The CPU core 10 obtains the data output from the ROM 40.

In this case, the data input/output control circuits 24 and 34 obtain the data read from the ROM 40 via a memory bus and store it into the data memories 22 and 32, respectively. The tag control circuits 23 and 33 update the data in the entries in the tag memories 21 and 31 corresponding to the entries storing the data.

Since the method of selecting an entry storing data in the data memories 22 and 32 and the updating of the entries in the tag memories 21 and 31 are similar to those in the above description, the description will not be repeated.

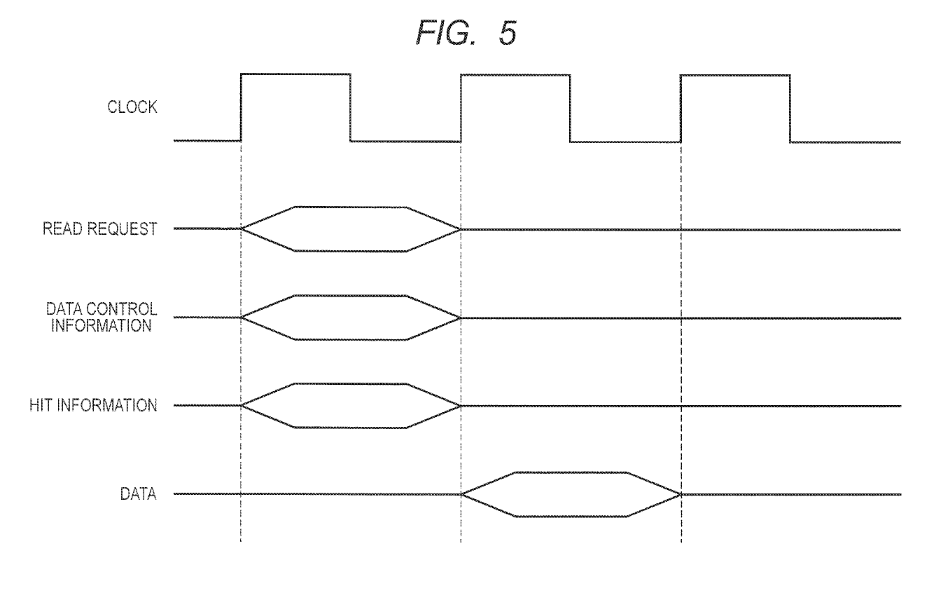

Subsequently, with reference to FIG. 5, the operation method of the first and second cache memories 20 and 30 according to the first embodiment will be described. FIG. 5 is a timing chart of signals (information) processed in the first and second cache memories 20 and 30 according to the first embodiment. In the following, the operation method illustrated in FIG. 5 will be also called “first method”.

In the case of reading data in the ROM 40, the CPU core 10 outputs a read request. The read request is information requesting reading of data from the ROM 40 and includes address information indicating the address of the data. As described above, the first and second cache memories 20 and 30 process the read request from the CPU core 10 with “zero wait”. Specifically, as illustrated in FIG. 5, according to output of the read request from the CPU core 10, data requested can be output to the CPU core 10 in a clock cycle next to a clock cycle in which the read request is output. Since the ROM 40 processes the read request from the CPU core 10 with eight waits, the requested data is output to the CPU core 10 in a clock cycle after nine clock cycles of the clock cycle in which the read request is output.

### First Clock Cycle

As illustrated in FIG. 5, the timing at which the read request is output from the CPU core 10 is set as the first clock cycle. In this case, the tag control circuits 23 and 33 of the first and second cache memories 20 and 30 retrieve an entry corresponding to an address indicated by address information included in the read request from the tag memory 21 in the first clock cycle and, according to the retrieval result, outputs data control information and hit information to the data input/output control circuits 24 and 34, respectively (hereinbelow, also called “entry retrieving operation”).

### Second Clock Cycle

In the second clock cycle, when the data control information is output from the tag control circuit 23, the data input/output circuit 24 in the first cache memory 20 obtains data stored in an entry indicated by the data control information and outputs it to the selection circuit 50. When hit information indicative of “no hit” is output from the tag control circuit 23 and the data control information is output from the tag control circuit 33, the data input/output control circuit 34 in the second cache memory 30 obtains data stored in an entry indicated by the data control information from the data memory 32 and outputs it to the selection circuit 50. On the other hand, in the case where hit information indicative of “hit” is output from the tag control circuit 23, even if the data control information is output from the tag control circuit 33, the data input/output control circuit 34 suppresses operation of obtaining data from the data memory 32 and outputting it (hereinbelow, also called “data outputting operation”).

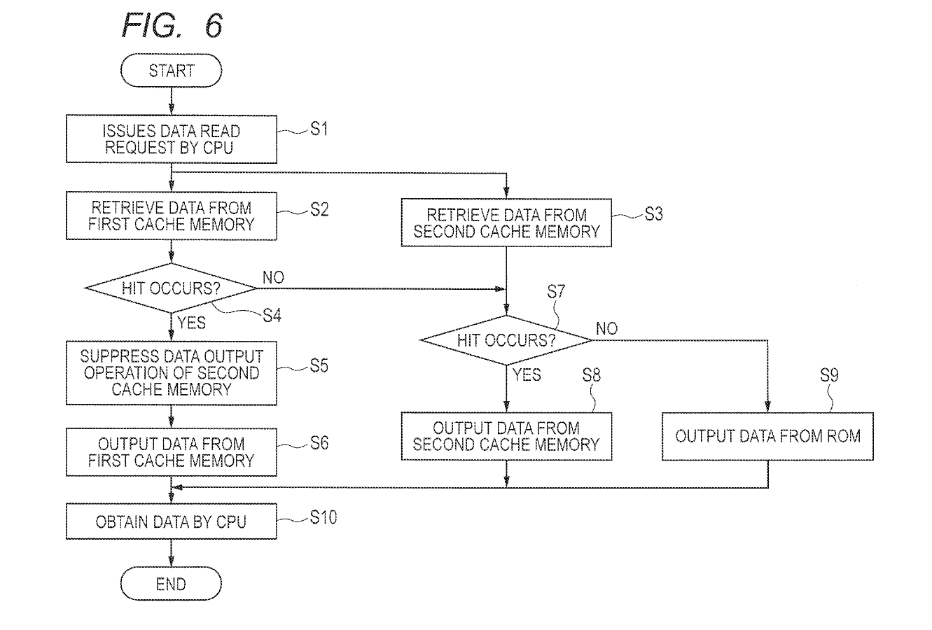

Subsequently, referring to FIG. 6, the operation of the semiconductor device 1 according to the first embodiment will be described. FIG. 6 is a flowchart illustrating the operation of the semiconductor device 1 according to the first embodiment.

In the case of reading data in the ROM 40, the CPU core 10 outputs a read request (S1). The tag control circuits 23 and 33 retrieve data from the first and second cache memories 20 and 30, respectively, in parallel on the basis of an address indicated by address information included in the read request (S2 and S3). More concretely, as described above, the tag control circuits 23 and 33 retrieve an entry indicative of a frame address matching a frame address in the address indicated by the address information from the tag memories 21 and 31, respectively.

When the tag control circuit 23 detects an entry matching the frame address and determines that a hit occurs (S4: Yes), the tag control circuit 23 outputs hit information indicative of “hit” to the data input/output control circuit 34 to suppress the data outputting operation of the data input/output control circuit 34 (S5). In this case, the tag control circuit 23 outputs data control information to the data input/output control circuit 24. The data input/output control circuit 24 obtains data from the data memory 22 in accordance with the data control information from the tag control circuit 23 and outputs it to the CPU core 10 via the selection circuit 50 (S6).

When the tag control circuit 23 cannot detect an entry matching the frame address and determines that a mishit occurs (S4: No) and the tag control circuit 33 detects an entry matching the frame address and determines a hit occurs (S7: Yes), the tag control circuit 23 outputs hit information indicative of “no hit” to the data input/output control circuit 34. The tag control circuit 33 outputs data control information to the data input/output control circuit 34. The data input/output control circuit 34 obtains data from the data memory 32 in accordance with the data control information from the tag control circuit 33 and outputs it to the CPU core 10 via the selection circuit 50 (S8).

When the tag control circuit 23 cannot detect an entry matching the frame address and determines that a mishit occurs (S4: No) and the tag control circuit 33 also cannot detect an entry matching the frame address and determines that a mishit occurs (S7: No), the ROM 40 outputs the data indicated by the address information included in the read request to the CPU core 10 (S9).

The CPU core 10 obtains the data output from any of the data input/output control circuit 24, the data input/output control circuit 34, and the ROM 40 (S10). By the operation, the reading of data by the CPU core 10 is completed.

As described above, in the first embodiment, the capacity of each of the first and second cache memories 20 and 30 is determined so that a total value of values obtained by adjusting current values of the first cache memory 20, the second cache memory 30, and the ROM 40 (main memory) in accordance with the hit ratios of the memories becomes a predetermine current threshold or less.

In the case of building a memory configuration in which two cache memories are combined, generally, the speed per cost is optimized. On the other hand, in the first embodiment, the capacity of each of the first and second cache memories 20 and 30 is determined so that a total value of values obtained by adjusting current values of the first cache memory 20, the second cache memory 30, and the ROM 40 (main memory) in accordance with the hit ratios of the memories becomes a predetermine current threshold or less. In this manner, the power consumption of the semiconductor device 1 can be reduced effectively.

In addition, in the first embodiment, the capacity of each of the first and second cache memories 20 and 30 is determined so that a total value of the area of the first cache memory 20 and the area of the second cache memory 30 becomes a predetermined area threshold or less. In this manner, the power consumption per area (cost) can be reduced. In other words, the area (cost) and the power consumption can be minimized.

In the first embodiment, when a data read request is generated from the CPU core 10 (high-order device) and a hit occurs in the first cache memory 20, the tag control circuit 23 stops at least a part of the operation of the second cache memory 30. More concretely, as stop of at least a part of the operation, output of data by the data input/output control circuit 34 (output control circuit) in the second cache memory 30 is suppressed. In this manner, by suppressing the operation of the second cache memory 30 which is unnecessary, the power consumption of the semiconductor device 1 can be reduced.

### Second Embodiment

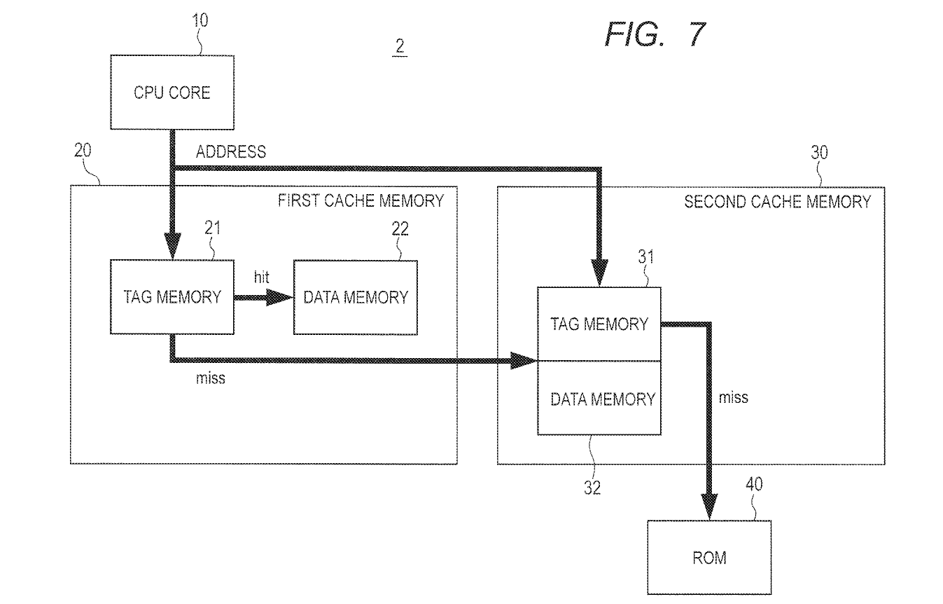

A second embodiment will now be described. In the following, the description of the second embodiment will not be properly repeated by adding the same reference numerals to components similar to those of the first embodiment. Referring to FIG. 7, the configuration of a semiconductor device 2 according to a second embodiment will be described. FIG. 7 is a block diagram illustrating the configuration of the semiconductor device 2 according to the second embodiment.

As illustrated in FIG. 7, the semiconductor device 2 according to the second embodiment has, like the semiconductor device 1 according to the first embodiment, the CPU core 10, the first cache memory 20, the second cache memory 30, and the ROM 40.

Different from the semiconductor device 1 according to the first embodiment, in the semiconductor device 2 according to the second embodiment, when a hit occurs in the first cache memory 20, not only the data outputting operation by the data input/output control circuit 34 in the second cache memory 30 is suppressed, but the operation after the hit is determined also in the entry retrieving operation by the tag control circuit 33 at the previous stage.

In the first embodiment, more concretely, the tag memory 31 is comprised of a flip flop (FF) and the data memory 32 is comprised of an SRAM (Static Random Access Memory). Consequently, retrieval of an entry can be performed at high speed. On the other hand, in the second embodiment, both of the tag memory 31 and the data memory 32 are comprised of SRAMs. Due to this, the speed of the retrieval of an entry by the tag control circuit 33 is lower than that in the first embodiment. However, by increasing the number of entries in the tag memory 31, the capacity of the second cache memory 30 can be increased.

The tag memory 21 in the first cache memory 20 is comprised of a flip flop, and the data memory 22 in the first cache memory 20 is comprised of an SRAM. That is, the speed of the retrieval of an entry by the tag control circuit 33 is lower than that of the retrieval of an entry by the tag control circuit 23.

Consequently, in the second embodiment, determination of whether a hit occurs in the first cache memory 20 or not by the tag control circuit 23 is performed earlier than determination of whether a hit occurs in the second cache memory 30 or not by the tag control circuit 33. In other words, when a determination result by the tag control circuit 23 is obtained, the tag control circuit 33 is executing the determination of whether a hit occurs in the second cache memory 30 or not (during retrieval of an entry in the tag memory 31). Therefore, in the second embodiment, as described above, when it is determined by the tag control circuit 23 that a hit occurs in the first cache memory 20, by suppressing the entry retrieving operation by the tag control circuit 33 afterwards, the data outputting operation is also suppressed.

Since the detailed configuration of the first and second cache memories 20 and 30 according to the second embodiment is similar to that of the first and second cache memories 20 and 30 according to the first embodiment illustrated in FIG. 4, the description will not be repeated. In the second embodiment, different from the first embodiment, as described above, the tag control circuit 23 outputs the hit information to the tag control circuit 33 in place of the data input/output control circuit 34.

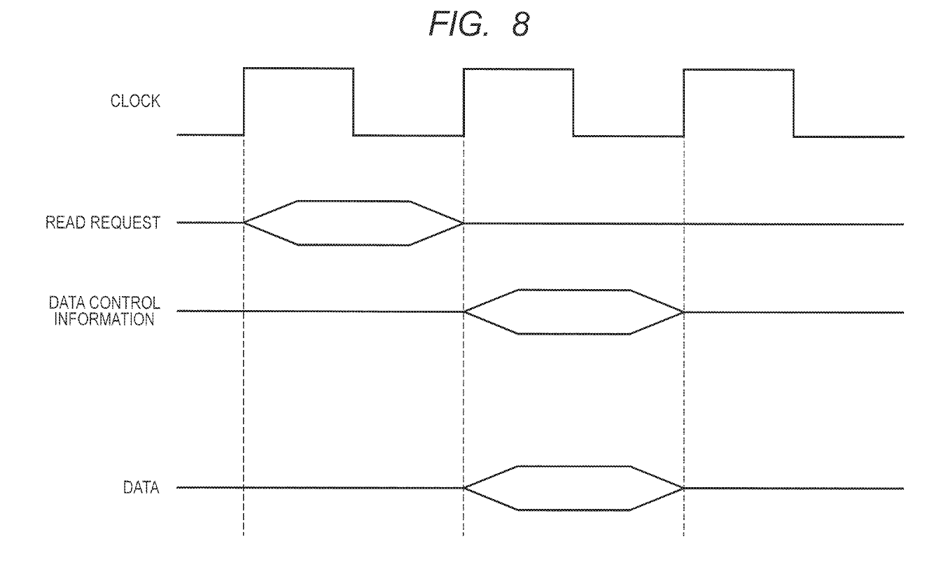

Subsequently, referring to FIG. 8, the operation method of the second cache memory 30 according to the second embodiment will be described. FIG. 8 is a timing chart of signals (information) processed in the second cache memory 30 according to the second embodiment. Hereinbelow, the operation method depicted in FIG. 8 will be also called a “second method”.

As described above, in the second embodiment, the speed of the entry retrieving operation by the second cache memory 30 is lower than that in the first embodiment. Therefore, in the second method depicted in FIG. 8, different from the first method of FIG. 5, the tag control circuit 33 in the second cache memory 30 outputs the data control information in the second clock cycle. Consequently, by outputting hit information in the first clock cycle by the tag control circuit 23, the entry retrieving operation by the tag control circuit 33 in the second cache memory 30 is stopped and output of the data control information can be suppressed.

Also in the second method, in the second clock cycle, the tag control circuit 33 obtains data from the data memory 32 in accordance with the data control information and outputs it to the CPU core 10. Therefore, also in the operation according to the second method, the tag control circuit 33 processes a read request from the CPU core 10 with zero wait.

Since the operation method of the first cache memory 20 is the first method depicted in FIG. 5, the description will not be repeated.

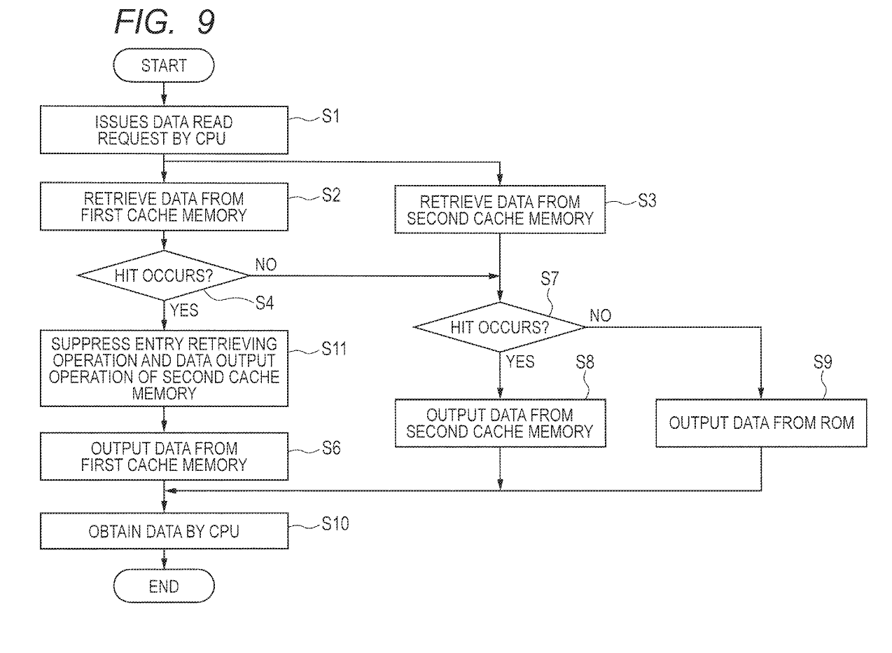

Subsequently, referring to FIG. 9, the operation of the second device 2 according to the second embodiment will be described. FIG. 9 is a flowchart illustrating operation of the semiconductor device 2 according to the second embodiment.

Different from the operation of the semiconductor device 1 according to the first embodiment illustrated in FIG. 6, the operation of the semiconductor device 2 according to the second embodiment has step S11 in place of step S6. Specifically, when the tag control circuit 23 determines that there is a hit (S4: Yes), the tag control circuit 23 outputs hit information indicative of the “hit” to the tag control circuit 33, thereby suppressing the following entry retrieving operation by the tag control circuit 33 and the data outputting operation by the data input/output control circuit 34 (S11). Since the other operations are similar to those in the first embodiment, the description will not be repeated.

As described above, in the second embodiment, when a data read request is generated from the CPU core 10 (high-order device) and a hit occurs in the first cache memory 20, the tag control circuit 23 stops at least a part of the operation of the second cache memory 30. More concretely, as stop of at least a part of the operation, retrieval of data by the tag control circuit 33 (retrieval circuit) in the second cache memory 30 is suppressed. Consequently, output of data performed after the retrieval of the data can be also suppressed, so that power consumption of the semiconductor device 1 can be reduced more.

### Third Embodiment

A third embodiment will now be described. In the following, repetition of the description of the third embodiment will be properly avoided by adding the same reference numerals to components similar to those of the first embodiment. Since the configuration of a semiconductor device 3 according to the third embodiment is similar to that of the semiconductor device 1 according to the first embodiment illustrated in FIG. 1, the description will not be repeated.

Although the operation frequencies of the CPU core 10, the first cache memory 20, and the third cache memory 30 are the same in the first and second embodiments, in the third embodiment, the operation in the case where the operation frequency of the second cache memory 30 is lower than the operation frequency of the CPU core 10 and the first cache memory 20 will be described. With the method, the power consumption of the second cache memory 30 can be reduced more. In the third embodiment, an example that operation frequency of the second cache memory 30 is the half of that of the CPU core 10 and the first cache memory 20 will be described. The ratio of the operation frequency of the second cache memory 30 to the operation frequency of the CPU core 10 and the first cache memory 20 is not limited to this example. Another ratio may be employed as long as the operation frequency of the second cache memory 30 is lower than the operation frequency of the CPU core 10 and the first cache memory 20.

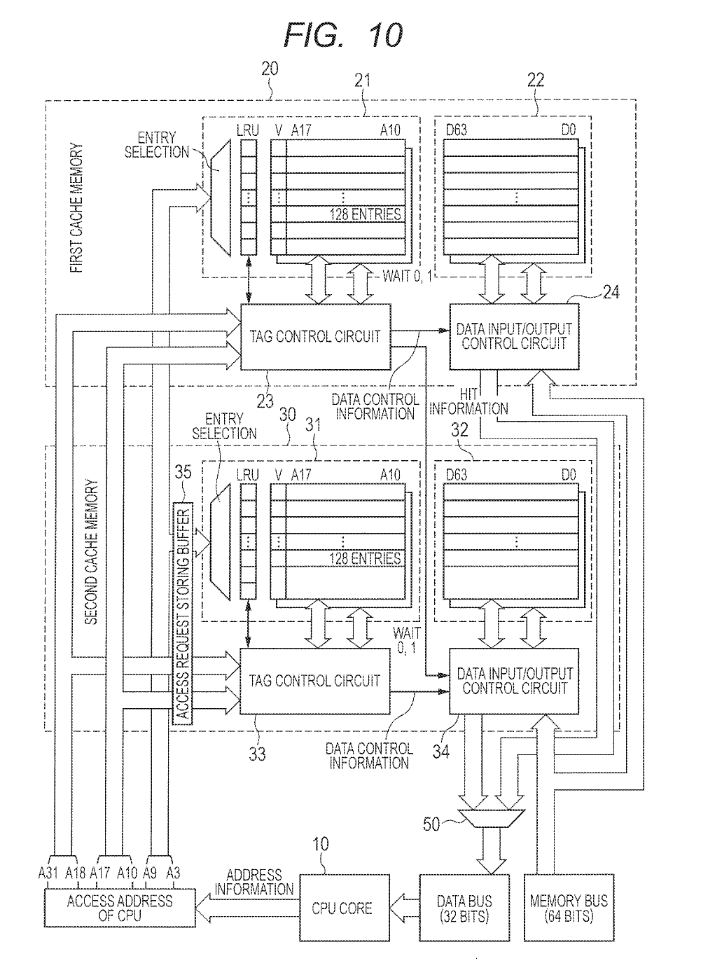

Subsequently, referring to FIG. 10, the detailed configuration of the first and second cache memories 20 and 30 according to the third embodiment will be described. FIG. 10 is a block diagram illustrating a detailed configuration of the first and second cache memories 20 and 30 according to the third embodiment.

As illustrated in FIGS. 5 and 8, the CPU core 10 outputs a read request (address information) only in one clock cycle (the first clock cycle) in operation clocks of the CPU core 10. However, in the third embodiment, in comparison to the first embodiment, as described above, the operation frequency of the second cache memory 30 is the half of the operation frequency of the CPU core 10 and the first cache memory 20. Consequently, the second cache memory 30 performs the entry retrieving operation in two clock cycles (the first and second clock cycles) which is twice as long as the clock cycle in which the read request is output. Therefore, in the configuration of the second cache memory 30 of the first embodiment, there is the possibility that, by receiving an output of address information different from address information (address information in one clock cycle) expected to be read in two clock cycles, the entry retrieval is not performed normally.

Different from the second cache memory according to the first embodiment, the second cache memory 30 according to the third embodiment has an access request storing buffer 35. The access request storing buffer 35 holds address information output from. The CPU core 10 and, also after end of outputting of the address information by the CPU core 10, continuously outputs the held address information to the inside of the second cache memory 30. For example, as described above, when the CPU core 10 finishes outputting of the address information in the first clock cycle, the access request storing buffer 35 outputs the held address information to the tag memory 31 and the tag control circuit 33 also in the second clock cycle. In this manner, the tag control circuit 23 can continue to refer to address information expected to be read. That is, it is sufficient to determine the number of clock cycles in which the access request storing buffer 35 holds and outputs address information, including the clock cycle in which a read request (address information) is output from the CPU core 10, as follows. The number of clock cycles in which the access request storing buffer 35 holds and outputs address information=the number of clock cycles in which the CPU core 10 outputs the read request (address information)×(operation frequency of the CPU core 10/operation frequency of the second cache memory 30)

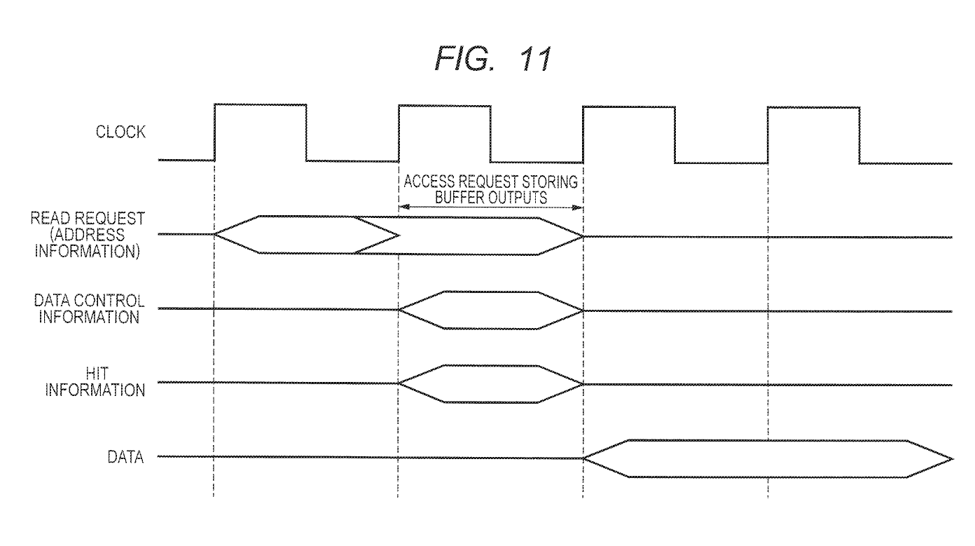

Subsequently, referring to FIG. 11, the operation of the second cache memory 30 according to the third embodiment will be described. FIG. 11 is a diagram illustrating a timing chart of signals (information) processed in the second cache memory 30 according to the third embodiment. The clocks in FIG. 11 are operation clocks of the CPU core 10 and the first cache memory 20.

### First Clock Cycle

In the case of reading data in the ROM 40, the CPU core 10 outputs a read request. The access request storing buffer 35 in the second cache memory 30 stores address information included in the read request. The tag control circuit 23 in the first cache memory 20 and the tag control circuit 33 in the second cache memory 30 perform the entry retrieving operation on the basis of the address information included in the read request.

### Second Clock Cycle

The CPU core 10 finishes outputting the read request. The tag control circuit 23 in the first cache memory 20 finishes the entry retrieving operation. The access request storing buffer 35 in the second cache memory 30 outputs the address information stored in the first clock cycle to the tag memory 31 and the tag control circuit 33. It enables the tag control circuit 33 in the second cache memory 30 to continue the entry retrieving operation also in the second clock cycle, and the entry retrieving operation can be continued normally on the basis of the address information output from the access request storing buffer 35. When a hit occurs, the tag control circuit 33 outputs data control information to the data input/output control circuit 34.

### Third and Fourth Clock Cycles

When the data control information is output from the tag control circuit 33, the data input/output control circuit 34 obtains data stored in an entry designated by the data control information from the data memory 32 and outputs it to the selection circuit 50.

### Modification of Third Embodiment

In the third embodiment, when the operation frequency of the second cache memory 30 is lower than that of the CPU core 10 and the first cache memory 20, by using the access request storing buffer 35, the second cache memory 30 can continue normal address information recognition. The present invention, however, is not limited to the embodiment.

For example, when hit information indicative of occurrence of a mishit is supplied from the tag control circuit 23 in the first cache memory 20, the tag control circuit 33 in the second cache memory 30 may output request information requesting continuation of output of the read request to the CPU core 10. In response to the request information from the tag control circuit 33, the CPU core 10 may continue outputting address information in the clock cycles until the tag control circuit 33 finishes the entry retrieving operation.

As described above, in the third embodiment, the operation frequency of the second cache memory 30 is lower than that of the CPU core 10 (high-order device) and the first cache memory 20. The second cache memory 30 has the access request storing buffer 35 for holding address information so that the tag control circuit 33 (retrieval circuit) can use the address information also after output of the read request by the CPU core 10. With the configuration, by lowering the operation frequency of the second cache memory 30, the power consumption can be lowered and the retrieving operation of the second cache memory 30 whose operation is low can be performed normally.

In the description of the first to third embodiments, to simplify the description, the example that a data read request is generated from the CPU core 10 has been described. Obviously, a data write request may be generated from the CPU core 10. In this case, the CPU core 10 outputs a write request as information including address information and data to be written. In a manner similar to the above, the tag control circuits 23 and 33 of the first and second cache memories 20 and 30 perform the entry retrieval with respect to the address indicated by the address information included in the write request. The data input/output control circuits 24 and 34 store the data included in the write request into entries of the data memories 22 and 32 indicated by the data control information output from the tag control circuits 23 and 33.

Although the present invention achieved by the inventors herein has been concretely described on the basis of the embodiments, obviously, the present invention is not limited to the foregoing embodiments and can be variously changed without departing from the gist.

In each of the foregoing first to third embodiments, the example of determining the capacity of each of the first and second cache memories 20 and 30 on the basis of the equation (1) has been described. However, the present invention is not limited to the example. The capacity of each of the first and second cache memories 20 and 30 may be determined by another method as long as a total value of values obtained by adjusting current values of the first cache memory 20, the second cache memory 30, and the ROM 40 in accordance with hit ratios of the memories becomes a predetermine current threshold or less. For example, the capacity may be determined so that a total value of values obtained as results of multiplying current values of the first cache memory 20, the second cache memory 30, and the ROM 40 with values proportional to the hit ratios of the memories becomes equal to or less than a predetermined current threshold.

In the first to third embodiments, the example of using an LRU as an algorithm of selecting an entry in which data is stored in the data memories 22 and 32 has been described. However, the present invention is not limited to the example. As an algorithm of selecting an entry in which data is stored in the data memories 22 and 32, the LFU (Least Frequently Used) may be employed. In this case, in the tag memories 21 and 31, in place of the LRU bit, LFU information indicative of data access frequency is stored.

Although the example that the number of ways in the first and second cache memories 20 and 30 is two has been described in the first to third embodiments, the other number of ways may be also employed.

What is claimed is:

1. A semiconductor device comprising:
a first cache memory;
a second cache memory whose power consumption is larger than that of the first cache memory; and
a main memory whose power consumption is larger than that of the second cache memory,
wherein capacity of each of the first and second cache memories is determined so that a total value of values obtained by adjusting current values of the first cache memory, the second cache memory, and the main memory in accordance with hit ratios of the memories becomes a predetermine current threshold or less.

2. The semiconductor device according to claim 1,
wherein area per a unit capacity in the second cache memory is smaller than that of the first cache memory, and
wherein the capacity of each of the first and second cache memories is determined so that a total value of the area of the first cache memory and the area of the second cache memory becomes a predetermined area threshold or less.

3. The semiconductor device according to claim 1, wherein the total value is a total value of results of multiplication between current values and hit ratios of the first cache memory, the second cache memory, and the main memory.

4. The semiconductor device according to claim 1,
wherein the second cache memory is a memory at a level lower than that of the first cache memory, and
wherein the semiconductor device further comprises a control circuit which stops operation of at least apart of the second cache memory when a data read request is generated from a higher-order device and a hit occurs in the first cache memory.

5. The semiconductor device according to claim 4,
wherein each of the first and second cache memories comprises:
a retrieval circuit, when a request to read data is generated from the high-order device, retrieving the data requested to be read; and
an output control circuit outputting the data detected by the retrieval circuit to the high-order device, and
wherein the control circuit suppresses output of the data by the output control circuit of the second cache memory as the stop of at least a part of the operation.

6. The semiconductor device according to claim 5, wherein the retrieval circuit in the first cache memory and the retrieval circuit in the second cache memory notify the output control circuit of a retrieval result in a clock cycle in which a data read request is generated from the high-order device.

7. The semiconductor device according to claim 4,
wherein each of the first and second cache memories has:
a retrieval circuit retrieving data requested to be read when the data read request is generated from the high-order device; and
an output control circuit outputting the data detected by the retrieval circuit to the high-order device, and
wherein the control circuit suppresses retrieval of the data by the retrieval circuit in the second cache memory as the stop of at least a part of the operation.

8. The semiconductor device according to claim 7,
wherein the retrieval circuit of the first cache memory notifies the output control circuit of a retrieval result in a clock cycle in which the data read request is generated from the high-order device, and
wherein the retrieval circuit in the second cache memory notifies the output control circuit of a retrieval result in a clock cycle after the clock cycle in which the data read request is generated from the high-order device.

9. The semiconductor device according to claim 1,
wherein each of the first and second cache memories has:
a retrieval circuit, when a data read request is generated from a high-order device, retrieving data on the basis of an address of data indicated by address information included in the read request; and
an output control circuit outputting data detected by the retrieval circuit to the high-order device,
wherein operation frequency of the second cache memory is lower than that of the high-order device and the first cache memory, and
wherein the second cache memory further includes a buffer for holding the address information so that the retrieval circuit can use the address information also after the end of the output of the read request by the high-order device.

10. The semiconductor device according to claim 1, wherein each of the first and second cache memories operates for a high-order device which generates a data read request with zero wait.

11. A cache memory control method comprising:
a determination step, when a data read request is generated from the high-order device, of determining whether a hit occurs in a first cache memory or not; and
a stopping step, when occurrence of a hit in the first cache memory is determined, of stopping at least a part of operation of a second cache memory at a level lower than the first cache memory.

12. The cache memory control method according to claim 11, further comprising:
a retrieving step of retrieving data requested to be read by each of the first and second cache memories in accordance with a data read request from the high-order device; and
an output step, when data is detected by the retrieval, of outputting the detected data to the high-order device by each of the first and second cache memories,
wherein in the stopping step, output of the data by the second cache memory is suppressed as the stop of at least a part of the operation.

13. The cache memory control method according to claim 11, further comprising:
a retrieving step of retrieving data requested to be read by each of the first and second cache memories in accordance with the data read request from the high-order device; and
an output step, when data is detected by the retrieval, of outputting the detected data to the high-order device by each of the first and second cache memories,
wherein in the stopping step, retrieval of the data by the second cache memory is suppressed as the stop of at least a part of the operation.
